(19) United States
(12) Patent Application Publication
(10) Pub. No.: US 2023/0250358 A1
(43) Pub. Date: Aug. 10, 2023

(54) SALICYLATE CONTAINING LUBRICATING OIL COMPOSITION FOR HYBRID VEHICLES

(71) Applicants: CHEVRON JAPAN LTD., Minato-ku, Tokyo (JP); CHEVRON ORONITE COMPANY LLC, San Ramon, CA (US)

(72) Inventors: Isao TANAKA, Makinohara City, Shizuoka (JP); John Robert MILLER, San Rafael, CA (US); Kyosuke AOYAMA, Ikeshinden, Omaezaki (JP)

(73) Assignees: CHEVRON JAPAN LTD., Minato-ku, Tokyo (JP); CHEVRON ORONITE COMPANY LLC, San Ramon, CA (US)

(21) Appl. No.: 18/014,355

(22) PCT Filed: Jul. 20, 2021
(86) PCT No.: PCT/IB2021/056526

§ 371 Date: Jan. 4, 2023

Related U.S. Application Data
(60) Provisional application No. 63/054,271, filed on Jul. 21, 2020.

(51) Int. Cl. C10M 169/04; C10M 129/54; C10M 129/70; C10M 133/44; C10M 139/00; C10M 141/12

(52) U.S. Cl. CPC C10M 169/04; C10M 129/54; C10M 129/70; C10M 133/44; C10M 139/00; C10M 141/12; C10M 2203/003; C10M 2207/262; C10M 2207/281; C10M 2215/30; C10M 2227/061; C10N 2040/25

(57) ABSTRACT

Disclosed is a method for reducing corrosion in a hybrid engine. The method includes the steps of lubricating a hybrid engine with a lubricating oil composition having a major amount of an oil of lubricating viscosity; a minor amount of a salicylate detergent derived from an isomerized normal alpha olefin; and a minor amount of a dispersant.

### BACKGROUND OF THE DISCLOSURE

Hybrid vehicles are driven mainly by an electric motor at low speeds and driven by an internal combustion engine at high speeds. A battery which powers the electric motor is typically charged through regenerative braking and by the internal combustion engine. There is a parallel system in which the motor assists the engine during acceleration. A series/parallel system distributes the power input from the engine and the motor in a well-balanced manner as the speed increases, with the main drive being the motor at the start and low speed.

In these hybrid vehicles, the engine is stopped when the vehicle comes to a stop, and the engine fuel system is also suspended when the vehicle is driven only by motor or braking. Therefore, the engine repeatedly goes through start-stop cycles during normal operation.

Consequently, the engine oil used for hybrid vehicles operates in a different environment compared to the engine oil of an automobile driven only by a conventional engine. Since hybrid vehicles run the engine only for short periods of time, there is the problem of accumulating water and fuel in the oil as the engine would not be able to sufficiently evaporate out the water and fuel through prolonged operation. This results in corrosion of engine parts which reduce engine life.

Therefore, a composition that improves the corrosion protection (i.e., reducing corrosion) of engine parts by is needed.

### SUMMARY OF THE DISCLOSURE

Disclosed is an internal combustion engine lubricating oil composition for reducing corrosion in the engine of a hybrid vehicle as determined by the modified ASTM D7563 method. Also disclosed are methods for using said lubricating oil composition for reducing corrosion in the engine of a hybrid vehicle.

In one aspect, there is provided a method for reducing corrosion in a hybrid engine, said method comprising lubricating a hybrid engine with a lubricating oil composition comprising: a major amount or an oil of lubricating viscosity, a minor amount of a salicylate detergent derived from an isomerized normal alpha olefin, and a minor amount of a dispersant.

In another aspect, there is provided a method for reducing corrosion and/or rust in a hybrid engine comprising: providing a lubricating oil composition comprising: a major amount of an oil of lubricating viscosity; a minor amount of a salicylate detergent derived from an isomerized normal alpha olefin having an isomerization level (1) of about 0.1 to about 0.4, wherein the isomerization level (I) represents the relative amount of methyl groups (—CH3) (chemical shift 0.30-1.01 ppm) attached to the methylene backbone groups (—CH2-) (chemical shift 1.01-1.38 ppm) and is defined by I=m/(m+n), where m is NMR integral for methyl groups with chemical shifts between 0.30±0.03 to 1.01+0.03 ppm, and n is NMR integral for methylene groups with chemical shifts between 1.01±0.03 to 1.38±0.10 ppm; and a minor amount of a dispersant; lubricating the hybrid engine with the lubricating oil composition; and operating said engine.

In a further aspect, there is provided a use of a lubricating oil composition comprising: a major amount of an oil of lubricating viscosity; a minor amount of a salicylate detergent, wherein the lubricating oil composition reduces corrosion in the engine of a hybrid vehicle as determined by the JIS K2246 method modified to use a test piece sample coated with a mixture containing test oil and distilled water; and a minor amount of a dispersant.

In yet another aspect, there is provided a use of a lubricating oil composition to reduce corrosion or rust in an engine of a hybrid vehicle, wherein the lubricating oil composition comprises: a major amount of an oil of lubricating viscosity; a minor amount of a salicylate detergent derived from isomerized normal alpha olefin having an isomerization level (I) of about 0.1 to about 0.4; and a minor amount of a dispersant, wherein the isomerization level (I) of the olefin was determined by hydrogen-1 (1H) NMR, and the isomerization level (I) represents the relative amount of methyl groups (—CH3) (chemical shift 0.30-1.01 ppm) attached to the methylene backbone groups (—CH2-) (chemical shift 1.01-1.38 ppm) and is defined by I=m/(m+n) where m is NMR integral for methyl groups with chemical shifts between 0.30±0.03 to 1.01±0.03 ppm, and n is NMR integral for methylene groups with chemical shifts between 1.01+0.03 to 1.38±0.10 ppm.

### DETAILED DESCRIPTION OF THE DISCLOSURE

While the disclosure is susceptible to various modifications and alternative forms, specific embodiments thereof are herein described in detail. It should be understood, however, that the description herein of specific embodiments is not intended to limit the disclosure to the particular forms disclosed, but on the contrary, the intention is to cover all modifications, equivalents, and alternatives falling within the spirit and scope of the disclosure as defined by the appended claims.

To facilitate the understanding of the subject matter disclosed herein, a number of terms, abbreviations or other shorthand as used herein are defined below. Any term, abbreviation or shorthand not defined is understood to have the ordinary meaning used by a skilled artisan contemporaneous with the submission of this application.

### Definitions

As used herein, the following terms have the following meanings, unless expressly stated to the contrary. In this specification, the following words and expressions, if and when used, have the meanings given below.

A “major amount” means in excess of 50 weight % of a composition.

A “minor amount” means less than 50 weight % of a composition, expressed in respect of the stated additive and in respect of the total mass of all the additives present in the composition, reckoned as active ingredient of the additive or additives.

“Active ingredients” or “actives” or “oil free” refers to additive material that is not diluent or solvent.

All percentages reported are weight % on an active ingredient basis (i.e., without regard to carrier or diluent oil) unless otherwise stated.

The abbreviation “ppm” means parts per million by weight, based on the total weight of the lubricating oil composition.

High temperature high shear (HTHS) viscosity at 150° C. was determined in accordance with ASTM D4683.

Kinematic viscosity at 100° C. (KV₁₀₀) was determined in accordance with ASTM D445.

Metal—The term “metal” refers to alkali metals, alkaline earth metals, or mixtures thereof.

Throughout the specification and claims the expression oil soluble or dispersible is used. By oil soluble or dispersible is meant that an amount needed to provide the desired level of activity or performance can be incorporated by being dissolved, dispersed or suspended in an oil of lubricating viscosity. Usually, this means that at least about 0.001% by weight of the material can be incorporated in a lubricating oil composition. For a further discussion of the terms oil soluble and dispersible, particularly “stably dispersible”, see U.S. Pat. No. 4,320,019 which is expressly incorporated herein by reference for relevant teachings in this regard.

The term “sulfated ash” as used herein refers to the non-combustible residue resulting from detergents and metallic additives in lubricating oil. Sulfated ash may be determined using ASTM Test D874.

The term “Total Base Number” or “TBN” as used herein refers to the amount of base equivalent to milligrams of KOH in one gram of sample. Thus, higher TBN numbers reflect more alkaline products, and therefore a greater alkalinity. TBN was determined using ASTM D 2896 test.

Boron, calcium, magnesium, molybdenum, phosphorus, sulfur, and zinc contents were determined in accordance with ASTM D5185.

Nitrogen content was determined in accordance with ASTM D4629.

All ASTM standards referred to herein are the most current versions as of the filing date of the present application.

Olefins—The term “olefins” refers to a class of unsaturated aliphatic hydrocarbons having one or more carbon-carbon double bonds, obtained by a number of processes. Those containing one double bond are called mono-alkenes, and those with two double bonds are called dienes, alkyldienes, or diolefins. Alpha olefins are particularly reactive because the double bond is between the first and second carbons. Examples are 1-octene and 1-octadecene, which are used as the starting point for medium-biodegradable surfactants. Linear and branched olefins are also included in the definition of olefins.

Normal Alpha Olefins—The term “Normal Alpha Olefins” “refers to olefins which are straight chain, non-branched hydrocarbons with carbon-carbon double bond present in the alpha or primary position of the hydrocarbon chain.

Isomerized Normal Alpha Olefin. The term “Isomerized Normal Alpha Olefin” as used herein refers to an alpha olefin that has been subjected to isomerization conditions which results in an alteration of the distribution of the olefin species present and/or the introduction of branching along the alkyl chain. The isomerized olefin product may be obtained by isomerizing a linear alpha olefin containing from about 10 to about 40 carbon atoms, preferably from about 20 to about 28 carbon atoms, and preferably from about 20 to about 24 carbon atoms.

C₁₀₋₄₀ Normal Alpha Olefins—This term defines a fraction of normal alpha olefins wherein the carbon numbers below 10 have been removed by distillation or other fractionation methods.

Unless otherwise specified, all percentages are in weight percent.

While the disclosure is susceptible to various modifications and alternative forms, specific embodiments thereof are herein described in detail. It should be understood, however, that the description herein of specific embodiments is not intended to limit the disclosure to the particular forms disclosed, but on the contrary, the intention is to cover all modifications, equivalents, and alternatives falling within the spirit and scope of the disclosure as defined by the appended claims.

Note that not all of the activities described in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described herein with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments.

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but may include other features not expressly listed or other features that are inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the embodiments of the disclosure. This description should be read to include one or at least one and the singular also includes the plural, or vice versa, unless it is clear that it is meant otherwise. The term “averaged,” when referring to a value, is intended to mean an average, a geometric mean, or a median value. Group numbers corresponding to columns within the Periodic Table of the elements use the “New Notation” convention as seen in the CRC Handbook of Chemistry and Physics, 81st Edition (2000-2001).

Unless otherwise defined, all technical and scientific terms used herein have the same meaning as commonly understood by one of ordinary skill in the art to which this disclosure belongs. The materials, methods, and examples are illustrative only and not intended to be limiting. To the extent not described herein, many details regarding specific materials and processing acts are conventional and may be found in textbooks and other sources within the lubricants as well a the oil and gas industries.

The specification and illustrations are not intended to serve as an exhaustive and comprehensive description of all the elements and features of formulations, compositions, apparatus and systems that use the structures or methods described herein. Separate embodiments may also be provided in combination in a single embodiment, and conversely, various features that are, for brevity, described in the context of a single embodiment, may also be provided separately or in any sub-combination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

Disclosed is an internal combustion engine lubricating oil composition which reduces corrosion in the engine of a hybrid vehicle comprising:
a major amount of an oil of lubricating viscosity;
a minor amount of a salicylate detergent; and
a minor amount of a dispersant.

Also disclosed is a method for reducing corrosion in a hybrid engine as determined by the modified JIS K2246 test (disclosed herein), said method comprising lubricating and operating the hybrid engine with a lubricating oil composition comprising:
a major amount of an oil of lubricating viscosity;
a minor amount of a salicylate detergent; and
a minor amount of a dispersant.

Also disclosed is the use of a lubricating oil composition to lubricate an internal combustion engine comprising:
a major amount of an oil of lubricating viscosity;
a minor amount of a salicylate detergent; and
a minor amount of a dispersant.

Also disclosed is the use of a lubricating oil composition to lubricate an internal combustion engine comprising:
a major amount of an oil of lubricating viscosity;
a minor amount of a salicylate detergent; and
a minor amount of a dispersant
wherein the lubricating oil composition reduced corrosion in the engine of a hybrid vehicle as determined by the modified JIS K2246 method.

In one or more embodiments described above, the salicylate detergent may be derived from an isomerized normal alpha olefin, wherein the isomerization level (I) of the olefin was determined by hydrogen-1 (1H) NMR, and wherein the NMR spectra were obtained on a Bruker Ultrashield Pius 400 in chloroform-d 1 at 400 MHz using TopSpin 3.2 spectral processing software, the isomerization level (I) represents the relative amount of methyl groups (—CH₃) (chemical shift 0.30-1.01 ppm) attached to the methylene backbone groups (—CH₂-) (chemical shift 1.01-1.38 ppm) and is defined by

I=m/(m+n)

where m is NMR integral for methyl groups with chemical shifts between 0.30±0.03 to 1.01±0.03 ppm, and n is NMR integral for methylene groups with chemical shifts between 1.01±0.03 to 1.38±0.10 ppm.

Oil of Lubricating Viscosity

The oil of lubricating, viscosity (sometimes referred to as “base stock” or “base oil”) is the primary liquid constituent of a lubricant, into which additives and possibly other oils are blended, for example to produce a final lubricant (or lubricant composition). A base oil is useful for making concentrates as well as for making lubricating oil compositions therefrom, and may be selected from natural and synthetic lubricating oils and combinations thereof.

Natural oils include animal and vegetable oils, liquid petroleum oils and hydrorefined, solvent-treated mineral lubricating oils of the paraffinic, naphthenic and mixed paraffinic-naphthenic types. Oils of lubricating viscosity derived from coal or shale are also useful base oils.

Synthetic lubricating oils include hydrocarbon oils such as polymerized and interpolymerized olefins (e.g., polybutylenes, polypropylenes, propylene-isobutylene copolymers, chlorinated polybutylenes, poly(l-hexenes), poly(l-octenes), poly(l-decenes); alkylbenzenes (e.g., dodecylbenzenes, tetradecylbenzenes, dinonylbenzenes, di(2-ethylhexyl)benzenes; polyphenols (e.g., biphenyls, terphenyls, alkylated polyphenols); and alkylated diphenyl ethers and alkylated diphenyl sulfides and the derivatives, analogues and homologues thereof.

Another suitable class of synthetic lubricating oils comprises the esters of dicarboxylic acids (e.g., malonic acid, alkyl malonic acids, alkenyl malonic acids, succinic acid, alkyl succinic acids and alkenyl succinic acids, maleic acid, fumaric acid, azelaic acid, suberic acid, sebacic acid, adipic acid, linoleic acid dimer, phthalic acid) with a variety of alcohols (e.g., butyl alcohol, hexyl alcohol, dodecyl alcohol, 2-ethylhexyl alcohol, ethylene glycol, diethylene glycol monoether, propylene glycol). Specific examples of these esters include dibutyl adipate, di(2-ethylhexyl) sebacate, di-n-hexyl fumarate, dioctyl sebacate, diisooctyl azelate, diisodecyl azelate, dioctyl phthalate, didecyl phthalate, dieicosyl sebacate, the 2-ethylhexyl diester of linoleic acid dimer, and the complex ester formed by reacting one mole of sebacic acid with two moles of tetraethylene glycol and two moles of 2-ethylhexanoic acid.

Esters useful as synthetic oils also include those made from C₅ to C₁₂ monocarboxylic acids and polyols, and polyol ethers such as neopentyl glycol, trimethylolpropane, pentaerythritol, dipentaerythritol and tripentaerythritol.

The base oil may be derived from Fischer-Tropsch synthesized hydrocarbons. Fischer-Tropsch synthesized hydrocarbons are made from synthesis gas containing H₂ and CO using a Fischer-Tropsch catalyst. Such hydrocarbons typically require further processing in order to be useful as the base oil. For example, the hydrocarbons may be hydroisomerized; hydrocracked and hydroisomerized; dewaxed; or hydroisomerized and dewaxed; using processes known to those skilled in the art.

Unrefined, refined and re-refined oils can be used in the present lubricating oil composition. Unrefined oils are those obtained directly from a natural or synthetic source without further purification treatment. For example, a shale oil obtained directly from retorting operations, a petroleum oil obtained directly from distillation or ester oil obtained directly from an esterification process and used without further treatment would be unrefined oil. Refined oils are similar to the unrefined oils except they have been further treated in one or more purification steps to improve one or more properties. Many such purification techniques, such as distillation, solvent extraction, acid or base extraction, filtration and percolation are known to those skilled in the art.

Re-refined oils are obtained by processes similar to those used to obtain refined oils applied to refined oils which have been already used in service. Such re-refined oils are also known as reclaimed or reprocessed oils and often are additionally processed by techniques for approval of spent additive and oil breakdown products.

Hence, the base oil which may be used to make the present lubricating oil composition may be selected from any of the base oils in Groups I-V as specified in the American Petroleum Institute (API) Base Oil Interchangeability Guidelines (API Publication 1509). Such base oil groups are summarized in Table 1 below:

TABLE 1

| | Base Oil Properties | | |
|---|---|---|---|
| Group^{(a)} | Saturates^{(b)}, wt. % | Sulfur^{(c)}, wt. % | Viscosity Index^{(d)} |
| Group I | <90 and/or | >0.03 | 80 to <120 |
| Group II | ≥90 | ≤0.03 | 80 to <120 |
| Group III | ≥90 | ≤0.03 | ≥120 |

| | |
|---|---|
| Group IV | Polyalphaolefins (PAOs) |
| Group V | All other base stocks not included in Groups I, II, III or IV |

^{(a)}Groups I-III are mineral oil base stocks.
^{(b)}Determined in accordance with ASTM D2007.
^{(c)}Determined in accordance with ASTM D2622, ASTM D3120, ASTM D4294 or ASTM D4927.
^{(d)}Determined in accordance with ASTM D2270.

Base oils suitable for use herein are any of the variety corresponding to API Group I, Group II, Group III, Group IV, and Group V oils and combinations thereof, preferably the Group III to Group V oils due to their exceptional volatility, stability, viscometric and cleanliness features.

The oil of lubricating viscosity for use in the lubricating oil compositions of this disclosure, also referred to as a base oil, is typically present in a major amount, e.g., an amount of greater than 50 wt. %, preferably greater than about 70 wt. %, more preferably from about 80 to about 99.5 wt. % and most preferably from about 85 to about 98 wt. %, based on the total weight of the composition. The expression “base oil” as used herein shall be understood to mean a base stock or blend of base stocks which is a lubricant component that is produced by a single manufacturer to the same specifications (independent of feed source or manufacturer's location); that meets the same manufacturer's specification; and that is identified by a unique formula, product identification number, or both. The base oil for use herein can be any presently known or later-discovered oil of lubricating viscosity used in formulating lubricating oil compositions for any and all such applications, e.g., engine oils, marine cylinder oils, functional fluids such as hydraulic oils, gear oils, transmission fluids, etc. Additionally, the base oils for use herein can optionally contain viscosity index improvers, e.g., polymeric alkylmethacrylates; olefinic copolymers, e.g., an ethylene-propylene copolymer or a styrene-butadiene copolymer; and the like and mixtures thereof.

As one skilled in the art would readily appreciate, the viscosity of the base oil is dependent upon the application. Accordingly, the viscosity of a base oil for use herein will ordinarily range from about 2 to about 2000 centistokes (cSt) at 100° Centigrade (C.). Generally, individually the base oils used as engine oils will have a kinematic viscosity range at 100° C. of about 2 cSt to about 30 cSt, preferably about 3 cSt to about 16 cSt, and most preferably about 4 cSt to about 12 cSt and will be selected or blended depending on the desired end use and the additives in the finished oil to give the desired grade of engine oil, e.g., a lubricating oil composition having an SAE Viscosity Grade of 0W, 0W-8, 0W-12, 0W-16, 0W-20, 0W-26, 0W-30, 0W-40, 0W-50, 0W-60, 5W, 5W-20, 5W-30, 5W-40, 5W-50, 5W-60, 10W, 10W-20, 10W-30, 10W-40, 10W-50, 15W, 15W-20, 15W-30, 15W-40, 30, 40 and the like.

Salicylate Detergent

Salicylate detergents may be prepared by reacting a basic metal compound with at least one carboxylic acid and removing water from the reaction product. Detergents made from salicylic acid are one class of detergents prepared from carboxylic acids. Useful salicylates include long chain alkyl salicylates. One useful family of compositions is of the following structure:

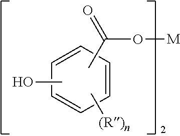

wherein R″ is a C₁ to C₃₀ (e.g., C₁₃ to C₃₀) alkyl group; n is an integer from 1 to 4; and M is an alkaline earth metal (e.g., Ca or Mg).

(00581 Hydrocarbyl-substituted salicylic acids may be prepared from phenols by the Kolbe reaction (see U.S. Pat. No. 3,595,791). The metal salts of the hydrocarbyl-substituted salicylic acids may be prepared by double decomposition of a metal salt in a polar solvent such as water or alcohol.

In one aspect of the present disclosure, the salicylate is derived from C₁₀-C₄₀) isomerized NAO and is made from an alkylphenol with an alkyl group derived from an isomerized NAO having an isomerization level (i) from about 0.10 to about 0.40, from about 0.10 to about 0.35, preferably from about 0.10 to about 0.30, from about 0.12 to about 0.30, from about 0.12 to about 0.25, from about 0.12 to about 0.23, from about 0.12 to about 0.22, from about 0.12 to about 0.20, from about 0.13 to about 0.19, from about 0.14 to about 0.18, from about 0.15 to about 0.17.

A typical detergent is an anionic material that contains a long chain hydrophobic portion of the molecule and a smaller anionic or oleophobic hydrophilic portion of the molecule. The anionic portion of the detergent is typically derived from an organic acid such as a sulfur acid, carboxylic acid, phosphorous acid, phenol, or mixtures thereof. The counterion is typically an alkaline earth or alkali metal.

Salts that contain a substantially stoichiometric amount of the metal are described as neutral salts and have a total base number (TBN) of from 0 to 80 mg KOH/g. Many compositions are overbased, containing large amounts of a metal base that is achieved by reacting an excess of a metal compound (e.g., a metal hydroxide or oxide) rich an acidic gas (e.g., carbon dioxide). Useful detergents can be neutral, mildly overbased, or highly overbased.

It is desirable for at least some detergent used in the detergent mixture to be overbased. Overbased detergents help neutralize acidic impurities produced by the combustion process and become entrapped in the oil. Typically, the overbased material has a ratio of metallic ion to anionic portion of the detergent of 1.05:1 to 50:1 (e.g., 4:1 to 25:1) on an equivalent basis. The resulting detergent is an overbased detergent that will typically have a TBN of 150 mg KOH/g or higher (e.g., 250 to 450 mg KOH/g or more).

The salicylate can be a calcium or magnesium salicylate. The calcium salicylate(s) detergent may be used in an amount that provides at least 250 ppm to 2400 ppm, 500 ppm to 2400 ppm, 750 ppm to 2200 ppm, 1000 ppm to 2200 ppm, 1000 ppm to 2000 ppm, 1000 ppm to 1800 ppm y weight of calcium to the lubricating oil composition. The magnesium salicylate(s) detergent may be used in an amount that provides at least 50 ppm to 2000, 50 ppm to 1500 ppm, 50 ppm to 1200 ppm, 50 ppm to 1000 ppm, 50 ppm to 800 ppm, 100 ppm to 1500 ppm, 150 ppm to 1200 ppm, 150 ppm to 1100 ppm, 200 ppm to 1000 ppm, 200 ppm to 800 ppm by weight of magnesium to the lubricating oil composition. A mixture of salicylates may be used.

Dispersants

Dispersants maintain in suspension materials resulting from oxidation during engine operation that are insoluble in oil, thus preventing sludge flocculation and precipitation or deposition on metal parts. Dispersants useful herein include nitrogen-containing, ashless (metal-free) dispersants known to effective to reduce formation of deposits upon use in gasoline and diesel engines.

Suitable dispersants include hydrocarbyl succinimides, hydrocarbyl succinimides, mixed ester/amides of hydrocarbyl-substituted succinic acid, hydroxyesters of hydrocarbyl-substituted succinic acid, and Mannich condensation products of hydrocarbyl-substituted phenols, formaldehyde and polyamines. Also suitable are condensation products of polyamines and hydrocarbyl-substituted phenyl acids. Mixtures of these dispersants can also be used.

Basic nitrogen-containing ashless dispersants are well-known lubricating oil additives and methods for their preparation are extensively described in the patent literature. Preferred dispersants are the alkenyl succinimides and succinimides where the alkenyl-substituent is a long-chain of preferably greater than 40 carbon atoms. These materials are readily made by reacting a hydrocarbyl-substituted dicarboxylic acid material with a molecule containing amine functionality. Examples of suitable amines are polyamines such as polyalkylene polyamines, hydroxy-substituted polyamines and polyoxyalkylene polyamines. Particularly preferred ashless dispersants are the polyisobutenyl succinimides formed from polyisobutenyl succinic anhydride and a polyalkylene polyamine such as a polyethylene polyamine of formula:

NH₂(CH₂CH₂NH)_{z}H

wherein z is 1 to 11. The polyisobutenyl group is derived from polyisobutene and preferably has a number average molecular weight (Mₙ) in a range of 700 to 3000 Daltons (e.g., 900 to 2500 Daltons). For example, the polyisobutenyl succinimide may be a bis-succinimide derived from a polyisobutenyl group having a Mₙ of about 900 to about 3000 Daltons. In one aspect, the bis-succinimide may be derived from a polyisobutenyl group having a Mₙ of about 900 to about 2500 Daltons. In one aspect, the bis-succinimide may be derived from a polyisobutenyl group having a Mₙ of about 1300 to about 2500 Daltons. In one aspect, the bis-succinimide may be derived from a polyisobutenyl group having a Mₙ of 2000 to 2500 Daltons. In another aspect, the bis-succinimide may be derived from a polyisobutenyl group having a Mₙ of 2300 Daltons.

As is known in the art, the dispersants may be post-treated with, for example, a boronating agent or a cyclic carbonate.

In one aspect, the bis-succinimide is a borated bis-succinimide derived from a polyisobutenyl group having a Mₙ of 1000 to 2500 Daltons. In another aspect, the bis-succinimide is a borated bis-succinimide derived from a polyisobutenyl group having a Mₙ of 1300 Daltons.

Nitrogen-containing ashless (metal-free) dispersants are basic, and contribute to the TBN of a lubricating oil composition to which they are added, without introducing additional sulfated ash. In one aspect, the dispersant is a non-post treated bis-succinimide dispersant. In another aspect, the dispersant is an ethylene carbonate post treated bis-succinimide dispersant. In another aspect, the dispersant is a borated bis-succinimide dispersant. In one aspect, the one or more dispersants may be present in an amount ranging from about 0.1 to about 10 wt. % (e.g., about 0.5 to about 8, about 0.7 to about 7, about 0.7 to about 6, about 0.7 to about 6, about 0.7 to about 5, about 0.7 to about 4 wt. %), based on an actives level of the lubricating oil composition. Nitrogen from the dispersants is present from greater than about 0.0050 to about 0.30 wt. % (e.g., greater than about 0.0050 to about 0.10 wt. %, about 0.0050 to about 0.080 wt. %, about 0.0050 to about 0.060 wt. %, about 0.0050 to about 0.050 wt. %, about 0.0050 to about 0.040 wt. %, about 0.0050 to about 0.030 wt. %) based on the weight of the dispersants in the finished oil.

Additional Lubricating Oil Additives

The lubricating oil compositions of the present disclosure may also contain other conventional additives that can impart or improve any desirable property of the lubricating oil composition in which these additives are dispersed or dissolved. Any additive known to a person of ordinary skill in the art may be used in the lubricating oil compositions disclosed herein. Some suitable additives have been described in Mortier et al., “Chemistry and Technology of Lubricants”, 2nd Edition, London, Springer, (1996); and Leslie R. Rudnick, “Lubricant Additives: Chemistry and Applications”, New York, Marcel Dekker (2003), both of which are incorporated herein by reference. For example, the lubricating oil compositions can be blended with antioxidants, anti-wear agents, detergents such as metal detergents, rust inhibitors, dehazing agents, demulsifying agents, metal deactivating agents, friction modifiers, pour point depressants, anti foaming agents, co-solvents, corrosion-inhibitors, dispersants, multifunctional agents, dyes, extreme pressure agents and the like and mixtures thereof. A variety of the additives are known and commercially available. These additives, or their analogous compounds, can be employed for the preparation of the lubricating oil compositions of the disclosure by the usual blending procedures.

In the preparation of lubricating oil formulations it is common practice to introduce the additives in the form of 10 to 100 wt. % active ingredient concentrates in hydrocarbon oil, e.g. mineral lubricating oil, or other suitable solvent.

Usually these concentrates may be diluted with 3 to 100, e.g., 5 to 40, parts by weight of lubricating oil per part by weight of the additive package in forming finished lubricants, e.g. crankcase motor oils. The purpose of concentrates, of course, is to make the handling of the various materials less difficult and awkward as well as to facilitate solution or dispersion in the final blend.

Each of the foregoing additives, when used, is used at a functionally effective amount to impart the desired properties to the lubricant. Thus, for example, if an additive is a friction modifier, a functionally effective amount of this friction modifier would be an amount sufficient to impart the desired friction modifying characteristics to the lubricant.

In general, the concentration of each of the additives in the lubricating oil composition, when used, may range from about 0.001 wt. % to about 20 wt. %, from about 0.01 wt. % to about 15 wt. %, or from about 0.1 wt. % to about 10 wt. %, from about 0.005 wt. % to about 5 wt. %, or from about 0.1 wt. % to about 2.5 wt. %, based on the total weight of the lubricating oil composition. Further, the total amount of the additives in the lubricating oil composition may range from about 0.001 wt. % to about 20 wt. %, from about 0.01 wt. % to about 10 wt. %, or from about 0.1 wt. % to about 5 wt. %, based on the total weight of the lubricating oil composition.

The following examples are presented to exemplify embodiments of the disclosure but are not intended to limit the disclosure to the specific embodiments set forth. Unless indicated to the contrary, all parts and percentages are by weight. All numerical values are approximate. When numerical ranges are given, it should be understood that embodiments outside the stated ranges may still fall within the scope of the disclosure. Specific details described in each example should not be construed as necessary features of the disclosure.

It will be understood that various modifications may be made to the embodiments disclosed herein. Therefore, the above description should not be construed as limiting, but merely as exemplifications of preferred embodiments. For example, the functions described above and implemented as the best mode for operating the present disclosure are for illustration purposes only. Other arrangements and methods may be implemented by those skilled in the art without departing from the scope and spirit of this disclosure. Moreover, those skilled in the art will envision other modifications within the scope and spirit of the claims appended hereto.

### EXAMPLES

The following examples are intended for illustrative purposes only and do not limit in any way the scope of the present disclosure.

The lubricating oils were evaluated for corrosion resistance by the modified HS method described below.

The lubricating oils were evaluated by the Japanese Industrial Standard (JIS) K2246 test that has been slightly modified for hybrid vehicle lubricants. In the modified JIS K2246 test, the test piece sample is coated with a mixture containing test oil and distilled water. The test piece sample is placed in a humidity cabinet above 95% relative humidity (RH) at 49° C. and allowed to stand for 72 hours. The test assesses the ability of oils to prevent rust on metal materials or metal products, mainly consisting of iron and steel. The A passing rating is normally 10 or below. ASTM 1)1748 test (Humidity cabinet rust test) is run in a similar fashion. The mixture containing test oil and distilled water was prepared according to the following steps:

1. Mix 30 ml of distilled water with 270 nil of test oil in a plastic container.

2. Transfer the mixture of test oil and distilled water to a 500 ml container.

3. Stir the mixture containing the test oil and distilled water on the day of the JIS K2246 test followed by 30 seconds handshaking.

4. Heat the test oil in a convection oven at 70° C. for 30 min.

5. After 30 minutes, remove the test oil from oven and allow the test oil to cool down to room temperature.

6. Just prior to soaking the test sample in the test oil, handshake the test oil again for 30 seconds.

7. Start the JIS K2246 test.

### Rating Method

Rating is conducted in the following manner:

1. Prepare a transparent plastic gauge with grid lines that fully covers test steel plate.

2. The gauge consists of grid lines having 0.5 mm width and 130 squires (5.5 mm×5.5 mm squire).

3. Count squires where rust is observed. Rust in a square counts as one towards the rating. Minimum is 0 and Maximum is 130.

Baseline Formulation

A lubricating oil composition was prepared by blending together the following components to obtain an SAE 0W-20 viscosity grade formulation:

approximately 770 ppm, in terms of phosphorus content, of a mixture of primary and secondary zinc dialkyldithiophosphate;

an alkylated diphenylamine antioxidant;

an ethylene propylene VII;

conventional amounts of pour point depressant,

foam inhibitor; and

the balance a mixture of Group III base oil.

Detergent A

An alkylated phenol and a Ca salicylate were prepared in substantially the same manner as in U.S. Pat. No. 8,993,499 using a C₂₀₋₂₄ isomerized normal alpha olefin. The isomerization level of the alpha olefin is about 0.16. The resulting salicylate composition has a TBN of about 630 and Ca content of about 22.4 wt. % on an oil-free basis.

Detergent B

An alkylated phenol and alkylated Ca salicylate were prepared in substantially the same manner as in U.S. Pat. No. 8,993,499 using a C₂₀₋₂₄ isomerized normal alpha olefin available from CP Chem. The isomerization level of the alpha olefin is about 0.16. The resulting alkylated salicylate composition has a TBN of about 225 and Ca content of 8 wt. % on an oil-free basis.

Detergent C

An alkylated phenol and alkylated Ca salicylate were prepared in substantially the same manner as in U.S. Pat. No. 8,030,258 using a C₂₀₋₂₈ normal alpha olefin available from CP Chem. The resulting alkylated salicylate composition has a TBN of about 520 and Ca content about 8 wt. % on an oil-free basis.

Detergent D

Detergent D is a C₂₀₋₂₄ calcium sulfonate detergent has a TBN of 700 and a Ca content of about 26.3 wt. % on an oil-free basis.

Detergent E

A slurry of MgO (82 grams) in MeOH (81.4 grams) and xylene (500 grams) is prepared and introduced into a reactor. Then the hydroxybenzoic acid made from isomerized alpha olefin (C20-24, 0.16 isomerization level), (1774 grams, 43% active in xylene) is loaded into the reactor and the temperature kept at 40° C. for 15 minutes. Then dodecenylanhydride (DDSA, 7.6 grams) followed by AcOH (37.3 grams) then H₂O (69 grams) are introduced in the reactor over 30 minutes while the temperature is ramped up to 50° C. CO₂ is then introduced in the reactor under strong agitation (96 grams). Then a slurry consisting of MgO (28 grams) in xylene (200 grams) is introduced in the reactor and a further quantity of CO₂ is bubbled through the mixture. At the end of CO₂ introduction, distillation of the solvent is accomplished by heating to 132° C. 500 grams of base oil is then introduced in the reactor. The mixture is then centrifuged in a lab centrifuge to remove unreacted magnesium oxide and other solid. Finally, the mixture is heated at 170° C. under vacuum (15 mbar) to remove the xylene and to lead to the final product containing 4.3% Magnesium as a C₂₀-C₂₄ magnesium alkylhydroxybenzoate detergent, made from isomerized NAO with isomerization level of 0.16. Properties: TBN (mgKOH/g)=199 in 35 wt % of diluent oil.

### Example 1

To the formulation baseline was added approximately 1670 ppm of Ca from detergent A and 4 wt % (based on concentrate) of a non-post treated bis-succinimide dispersant.

### Example 2

To the formulation baseline was added approximately 1670 ppm of Ca from detergent A and 4 wt. % (based on concentrate) of an ethylene carbonate post-treated bis-succinimide dispersant.

### Example 3

To the formulation baseline was added approximately 1670 ppm of Ca from detergent A and 4 wt. % (based on concentrate) of a borated bis-succinimide dispersant.

### Example 4

To the formulation baseline was added approximately 1670 ppm of Ca from detergent B and 4 wt. % (based on concentrate) of a non-post treated bis-succinimide dispersant (same kind and amount as Ex. 1).

### Example 5

To the formulation baseline was added approximately 1670 ppm of Ca from detergent B and 4 wt. % (based on concentrate) of an ethylene carbonate post-treated bis-succinimide dispersant (same kind and amount as Ex. 2).

### Example 6

To the formulation baseline was added approximately 1670 ppm of Ca from detergent B and 4 wt. % (based on concentrate) of a borated bis-succinimide dispersant (same kind and amount as Ex. 3).

### Example 7

To the formulation baseline was added approximately 1040 ppm of Mg from detergent E and 4 wt. % (based on concentrate) of a non-post treated bis-succinimide dispersant (same kind and amount as Ex. 1).

### Example 8

To the formulation baseline was added approximately 1040 ppm of Mg from detergent E and 4 wt. % (based on concentrate) of an ethylene carbonate post-treated bis-succinimide dispersant (same kind and amount as Ex. 2).

### Example 9

To the formulation baseline was added approximately 1040 ppm of Mg from detergent E and 4 wt. % (based on concentrate) of a borated bis-succinimide dispersant (same kind and amount as Ex. 3).

### Example 10

To the formulation baseline was added approximately 260 ppm of Mg from detergent E and 4 wt. % (based on concentrate) of an ethylene carbonate post-treated dispersant (same kind and amount as Ex. 2).

### Example 11

To the formulation baseline was added approximately 520 ppm of Mg from detergent E and 4 wt. % (based on concentrate) of an ethylene carbonate post-treated dispersant (same kind and amount as Ex. 2).

### Example 12

To the formulation baseline was added approximately 1040 ppm of Mg from detergent E and 2 wt. % (based on concentrate) of an ethylene carbonate post-treated dispersant (same kind and amount as Ex. 2).

### Example 13

To the formulation baseline was added approximately 1040 ppm of Mg from detergent E and 1 wt. % (based on concentrate) of an ethylene carbonate post-treated dispersant (same kind and amount as Ex. 2).

### Example 14

To the formulation baseline was added approximately 520 ppm of Mg from detergent E and 2 wt. % (based on concentrate) of an ethylene carbonate post-treated dispersant (same kind and amount as Ex. 2).

### Comparative Example 1

To the formulation baseline was added approximately 1670 ppm of Ca from an detergent D and 4 wt. % (based on concentrate) of a non-post treated bis-succinimide dispersant (same kind and amount as Ex. 1).

### Comparative Example 2

To the formulation baseline was added approximately 1670 ppm of Ca from an detergent D and 4 wt. % (based on concentrate) of an ethylene carbonate post-treated bis-succinimide dispersant (same kind and amount as Ex. 2).

### Comparative Example 3

To the formulation baseline was added approximately 1670 ppm of Ca from an detergent D and 4 wt. % (based on concentrate) of a borated bis-succinimide dispersant (same kind and amount as Ex. 3).

### Comparative Example 4

To the formulation baseline was added approximately 1670 ppm of Ca from an detergent C and 4 wt. % (based on concentrate) of a non-post treated bis-succinimide dispersant (same kind and amount as Ex. 1).

### Comparative Example 5

To the formulation baseline was added approximately 1670 ppm of Ca from an detergent C and 4 wt. % (based on concentrate) of an ethylene carbonate post-treated bis-succinimide dispersant (same kind and amount as Ex. 2).

### Comparative Example 6

To the formulation baseline was added approximately 1670 ppm of Ca from an detergent C and 4 wt. % (based on concentrate) of a borated bis-succinimide dispersant (same kind and amount as Ex. 3).

The isomerization level was measured by an NMR method.

### Isomerization Level (I) and NMR Method

The isomerization level (1) of the olefin was determined by hydrogen-1 (1H) NMR. The NMR spectra were obtained on a Bruker Ultrashield Plus 400 in chloroform-di at 400 MHz using TopSpin 3.2 spectral processing software.

The isomerization level (1) represents the relative amount of methyl groups (—CH₃) (chemical shift 0.30-1.01 ppm) attached to the methylene backbone groups (—CH₂-) (chemical shift 1.01-1.38 ppm) and is defined by the Formula shown below,

I=m/(m+n)

where m is NMR integral for methyl groups with chemical shifts between 0.30±0.03 to 1.01±0.03 ppm, and n is NMR integral for methylene groups with chemical shifts between 1.01±0.03 to 1.38+0.10 ppm.

TABLE 2

| | | | | | | Corrosion |
|---|---|---|---|---|---|---|
| | | | | | | Test |
| | | | Ca from | Mg from | Dispersant | Result |
| | Detergent | Dispersant | detergent | detergent | Content | (JIS |
| | Type | Type | (ppm) | (ppm) | (wt %) | K2246) |
| Example 1 | A | Bis- | 1670 | 0 | 4 | 9 |
| | | succinimide | | | | |
| Example 2 | A | EC-treated | 1670 | 0 | 4 | 4 |
| Example 3 | A | Borated | 1670 | 0 | 4 | 4 |
| Example 4 | B | Bis- | 1670 | 0 | 4 | 7 |
| | | succinimide | | | | |
| Example 5 | B | EC-treated | 1670 | 0 | 4 | 3 |
| Example 6 | B | Borated | 1670 | 0 | 4 | 5 |
| Example 7 | E | Bis- | 0 | 1040 | 4 | 8 |
| | | succinimide | | | | |
| Example 8 | E | EC-treated | 0 | 1040 | 4 | 5 |
| Example 9 | E | Borated | 0 | 1040 | 4 | 6 |
| Example 10 | E | EC-treated | 0 | 260 | 4 | 11 |
| Example 11 | E | EC-treated | 0 | 520 | 4 | 2 |
| Example 12 | E | EC-treated | 0 | 1040 | 2 | 3 |
| Example 13 | E | EC-treated | 0 | 1040 | 1 | 10 |
| Example 14 | E | EC-treated | 0 | 520 | 2 | 9 |
| Comparative | D | Bis- | 1670 | 0 | 4 | 45 |
| Example 1 | | succinimide | | | | |
| Comparative | D | EC-treated | 1670 | 0 | 4 | 28 |
| Example 2 | | | | | | |
| Comparative | D | Borated | 1670 | 0 | 4 | 44 |
| Example 3 | | | | | | |
| Comparative | C | Bis- | 1670 | 0 | 4 | 32 |
| Example 4 | | succinimide | | | | |
| Comparative | C | EC-treated | 1670 | 0 | 4 | 36 |
| Example 5 | | | | | | |
| Comparative | C | Borated | 1670 | 0 | 4 | 25 |
| Example 6 | | | | | | |

What is claimed:

1. A method for reducing corrosion in a hybrid engine, said method comprising lubricating a hybrid engine with a lubricating oil composition comprising:
a. a major amount of an oil of lubricating viscosity;
b. a minor amount of a salicylate detergent derived from an isomerized normal alpha olefin; and
c. a minor amount of a dispersant.

2. The method of claim 1, wherein the detergent is a magnesium salicylate, calcium salicylate detergent, or a combination thereof.

3. The method of claim 1, wherein the composition reduces corrosion in the engine of a hybrid vehicle.

4. The method of claim 1, wherein the isomerized normal alpha olefin has an isomerization level (I) of the normal alpha olefin of from about 0.1 to about 0.4 as measured by 1H NMR, wherein the isomerization level (I) represents the relative amount of methyl groups (—CH3) (chemical shift 0.30-1.01 ppm) attached to the methylene backbone groups (—CH2-) (chemical shift 1.01-1.38 ppm) and is defined by
I=m/(m+n)
where m is NMR integral for methyl groups with chemical shifts between 0.30+0.03 to 1.01±0.03 ppm, and n is NMR integral for methylene groups with chemical shifts between 1.01±0.03 to 1.38±0.10 ppm.

5. The method of claim 4, wherein the isomerized normal alpha olefin has an isomerization level (I) of the normal alpha olefin of from about 0.1 to about 0.3.

6. The method of claim 4, wherein the isomerized normal alpha olefin has an isomerization level (I) of the normal alpha olefin of from about 0.12 to about 0.25.

7. The method of claim 1, wherein the dispersant is a non-post treated bis-succinimide dispersant, an ethylene carbonate post treated bis-succinimide dispersant, a borated bis-succinimide dispersant, or a combination thereof.

8. The method of claim 1, wherein the salicylate detergent provides about 100 to about 2000 ppm of a metal based on the lubricating oil composition.

9. The method of claim 1, wherein the dispersant is present in about 0.5 wt % to about 5 wt % based on the lubricating oil composition.

10. A method for reducing corrosion and/or rust in a hybrid engine comprising:
a. providing a lubricating oil composition comprising:
a major amount of an oil of lubricating viscosity;
a minor amount of a salicylate detergent derived from an isomerized normal alpha olefin having an isomerization level (I) of about 0.1 to about 0.4, wherein the isomerization level (I) represents the relative amount of methyl groups (—CH3) (chemical shift 0.30-1.01 ppm) attached to the methylene backbone groups (—CH2-) (chemical shift 1.01-1.38 ppm) and is defined by I=m/(m+n), where m is NMR integral for methyl groups with chemical shifts between 0.30±0.03 to 1.01±0.03 ppm, and n is NMR integral for methylene groups with chemical shifts between 1.01+0.03 to 1.38=0.10 ppm; and
a minor amount of a dispersant;
b. lubricating the hybrid engine with the lubricating oil composition; and
c. operating said engine.

11. The method of claim 10, reduction of corrosion and/or rust is determined by JIS K2246 test.

12. The method of claim 11, wherein the JIS K2246 test has been modified such that the test piece sample is coated with a mixture containing test oil and distilled water.

13. The use of a lubricating oil composition comprising:
a. a major amount of an oil of lubricating viscosity;
b. a minor amount of a salicylate detergent,
wherein the lubricating oil composition reduces corrosion in the engine of a hybrid vehicle as determined by the JIS K2246 method modified to use a test piece sample coated with a mixture containing test oil and distilled water; and
c. a minor amount of a dispersant.

14. The use of claim 13, wherein the salicylate detergent is derived from isomerized normal alpha olefin having an isomerization level (I) of about 0.1 to about 0.4, wherein the isomerization level (I) represents the relative amount of methyl groups (—CH3) (chemical shift 0.30-1.01 ppm) attached to the methylene backbone groups (—CH2-) (chemical shift 1.01-1.38 ppm) and is defined by 1=m/(m+n), where m is NMR integral for methyl groups with chemical shifts between 0.30±0.03 to 1.01+0.03 ppm, and n is NMR integral for methylene groups with chemical shifts between 1.01±0.03 to 1.38±0.10 ppm

15. The use of a lubricating oil composition to reduce corrosion or rust in an engine of a hybrid vehicle, wherein the lubricating oil composition comprises:
a major amount of an oil of lubricating viscosity;
a minor amount of a salicylate detergent derived from isomerized normal alpha olefin having an isomerization level (I) of about 0.1 to about 0.4; and
a minor amount of a dispersant, wherein the isomerization level (I) of the olefin was determined by hydrogen-1 (1H) NMR, and the isomerization level (I) represents the relative amount of methyl groups (—CH₃) (chemical shift 0.30-1.01 ppm) attached to the methylene backbone groups (—CH₂—) (chemical shift 1.01-1.38 ppm) and is defined by
I=m/(m+n)
where m is NMR integral for methyl groups with chemical shifts between 0.30±0.03 to 1.01±0.03 ppm, and n is NMR integral for methylene groups with chemical shifts between 1.01±0.03 to 1.38±0.10 ppm.
